(19) United States
(12) Patent Application Publication
(10) Pub. No.: US 2016/0048117 A1
(43) Pub. Date: Feb. 18, 2016

(54) ELECTRONIC DEVICE AND METHOD OF ROTATING ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-JUN MAO, Shenzhen (CN); CHIH-SAN CHIANG, New Taipei (TW); YA-LING LIU, Shenzhen (CN)

(21) Appl. No.: 14/575,658

(22) Filed: Dec. 18, 2014

(30) Foreign Application Priority Data
Aug. 12, 2014 (CN) 201410393943.5

(51) Int. Cl. G05B 19/048; G05B 15/02

(52) U.S. Cl. CPC G05B 19/048; G05B 15/02; G05B 2219/39483

(57) ABSTRACT

An electronic device includes a sensing module and a processing module. The processing module stores a reference value and a control value. The sensing module is configured to sense a rotation of an electronic device to receive a rotation signal when the electronic device rotates. The processing module is configured to transform the rotation signal to a current value after reading the rotation signal. The processing module is configured to reset the control value to the current value upon determining that the current value is not equal to the reference value. The processing module is configured to control the electronic device to rotate according to the control value. A method of rotating the electronic device is also provided.

### CROSS-REFERENCE TO RELATED APPLICATIONS

This application claims priority to Chinese Patent Application No. 201410393943.5 Aug. 12, 2014, the contents of which are incorporated by reference herein.

### FIELD

The subject matter herein generally relates to an electronic device and a method of rotating the electronic device.

### BACKGROUND

A method of rotating an electronic device may be used to control the electronic device to rotate.

### BRIEF DESCRIPTION OF THE DRAWINGS

Implementations of the present technology will now be described, by way of example only, with reference to the attached figures.

FIG. 1 is a block diagram of one embodiment of an electronic device.

FIG. 2 is a flowchart of one embodiment of a method of rotating the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series, and the like.

The present disclosure is described in relation to an electronic device and a method of rotating the electronic device.

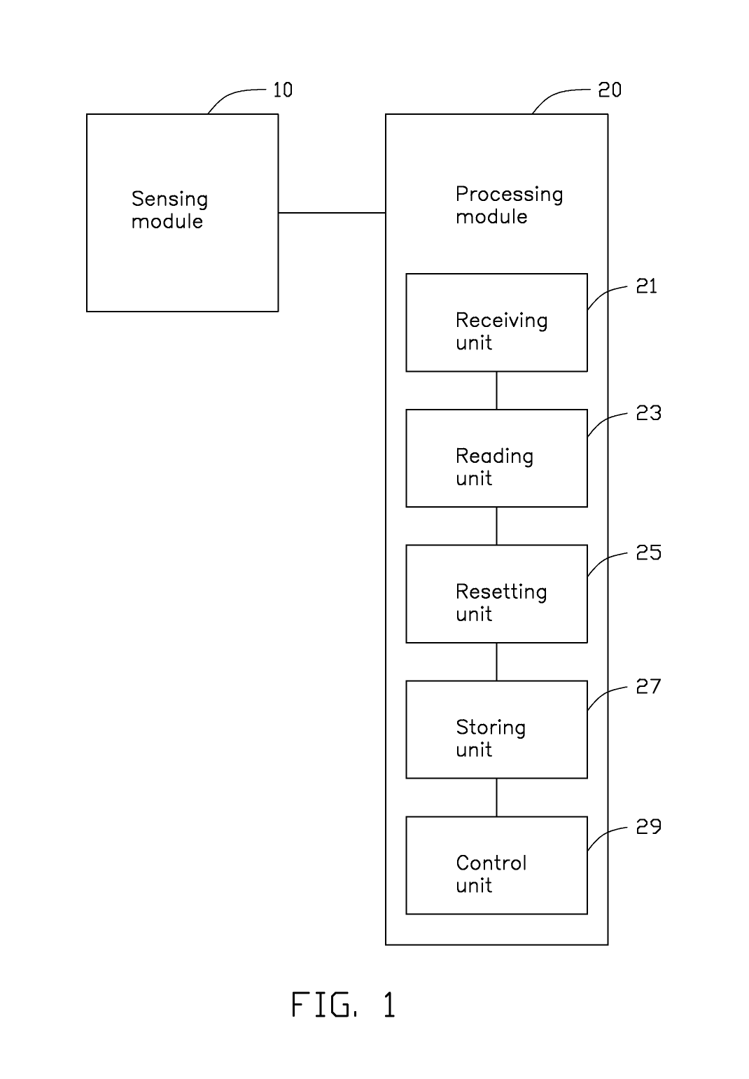

FIG. 1 illustrates one embodiment of an electronic device. The electronic device comprises an electronic device body (not shown), a sensing module 10, and a processing module 20. The sensing module 10 is configured to sense if the electronic device body is rotating. The processing module 20 is configured to control a screen of the electronic device to rotate according to the rotation of electronic device body. In one embodiment, the sensing module 10 is a gravireceptor and the processing module 20 is a central processing unit (CPU). The sensing module 10 is configured to receive a rotation signal after sensing the rotation of the electronic device.

The processing module 20 comprises a receiving unit 21, a reading unit 23, a resetting unit 25, a storing unit 27, and a control unit 29. The receiving unit 21 is configured to receive the rotation signal from the sensing module 10. The reading unit 23 is configured to read the rotation signal from the receiving unit 21 and transform the rotation signal to a current value. The storing unit 27 is configured to store a first address value, a second address value, a control value, and a reference value. The control unit 29 is configured to receive the reference value according to the first address value and receive the control value according to the second address value. The control unit 29 is also configured to compare the reference value with the control value. The resetting unit 25 is configured to reset the control value to the current value.

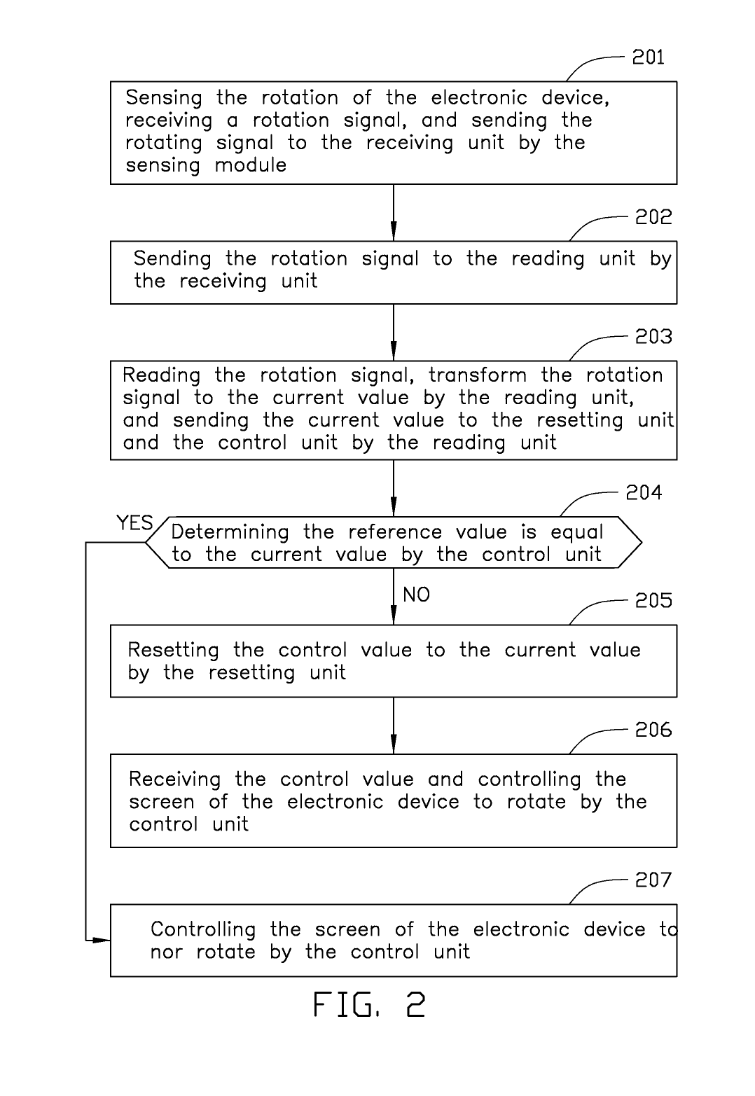

FIG. 2 illustrates a flowchart in accordance with an example embodiment. A method of rotating the electronic device is provided by way of example, as there are a variety of ways to carry out the method. The method of rotating the electronic device described below can be carried out using the configurations illustrated in FIG. 1, for example, and various elements of these figures are referenced in explaining method for the electronic device rotating. In FIG. 2 each block represents one or more processes, methods, or subroutines carried out in the voice-recognition method. Furthermore, the illustrated order of blocks is by example only and the order of the blocks can change. Additional blocks may be added or fewer blocks may be utilized, without departing from this disclosure. The method of rotating the electronic device can begin at block 201.

At block 201, the sensing module 10 senses the electronic device rotating, receives a rotation signal and sends the rotation signal to the receiving unit 20.

At block 202, the receiving unit 21 sends the rotation signal to the reading unit 23.

At block 203, the reading unit 23 reads the rotation signal, transforms the rotation signal to the current value and sends the current value to the resetting unit 25 and the control unit 29.

At block 204, the control unit 29 compares the reference value with the current value after receiving the reference value according to the first address value and receiving the control value according to the second address value, goes to step 205 when the reference value is not equal to the current value; and goes on step 207 when the reference value is equal to the current value.

At block 205, the resetting unit 25 resets the control value to the current value when the control unit 29 determines the reference value is not equal to the current value.

At block 206, the control unit 29 receives the control value according to the second address value and controls the screen of the electronic device to rotate.

At block 207, the control unit 29 controls the screen of the electronic device to not rotate.

In the electronic device, the resetting unit 25 resets the control value to the current value when the control unit 29 determines the reference value is not equal to the current value. The control unit 29 receives the control value according to the second address value. Thereby the control unit 29 controls the screen of the electronic device to rotate.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. An electronic device comprising:
a sensing module; and
a processing module configured to store a reference value and a control value,
wherein, the sensing module is configured to sense a rotation of the electronic device rotating; and
wherein, the processing module is configured to:
transform the rotation signal to a current value after reading the rotation signal;
reset the control value to the current value upon determining that the current value is not equal to the reference value; and
control the electronic device to rotate according to the control value.

2. The electronic device of claim 1, wherein the control module comprises a resetting unit and a control unit, the control unit is configured to compare the current value with the reference value, and the resetting unit is configured to reset the control value to the current value when the control value is not equal to the current value.

3. The electronic device of claim 1, wherein the control module comprises a resetting unit and a control unit, the control unit is configured to compare the current value with the reference value, and the resetting unit is configured to reset the control value to the current value when the control value is not equal to the current value.

4. The electronic device of claim 1, wherein the control module comprises a storing unit and a control unit, the storing unit is configured to store a first address value, and the control unit is configured to receive the reference value according to the first address value.

5. The electronic device of claim 4, wherein the storing unit is also configured to store a second address value and the control unit is configured to receive the control value according to the second address value.

6. The electronic device of claim 1, wherein the control module comprises a reading unit, the reading unit is configured to transform the rotation signal to the current value after reading the rotation signal.

7. The electronic device of claim 1, wherein the sensing module is a gravireceptor.

8. The electronic device of claim 1, wherein the processing module is a central processing unit.

9. An electronic device comprising:
a sensing module; and
a processing module having a control unit and configured to store a reference value and a control value;
wherein, the sensing module is configured to sense a rotation of an electronic device rotating to receive a rotation signal;
wherein, the processing module is configured to transform the rotation signal to a current value after reading the rotation signal;
wherein, the control unit is configured to compare the current value with the reference value;
wherein, the processing module is configured to reset the control value to the current value upon determining that the current value is not equal to the reference value, and
wherein, the control unit is configured to control the electronic device to rotate according to the control value.

10. The electronic device of claim 9, wherein the control module further comprises a resetting unit and the resetting unit is configured to reset the control value to the current value upon determining that the control value is not equal to the current value.

11. The electronic device of claim 9, wherein the control module further comprises a resetting unit and a control unit, the control unit is configured to compare the current value and the reference value, and the resetting unit is configured to reset the control value to the current value upon determining that the control value is not equal to the current value.

12. The electronic device of claim 9, wherein the control module further comprises a storing unit, the storing unit is configured to store a first address value, and the control unit is configured to receive the reference value according to the first address value.

13. The electronic device of claim 12, wherein the storing unit is also configured to store a second address value and the control unit is configured to receive the control value according to the second address value.

14. The electronic device of claim 9, wherein the control module further comprises a reading unit, the reading unit is configured to transform the rotation signal to the current value after reading the rotation signal.

15. The electronic device of claim 14, wherein the control module further comprises a receiving unit, the receiving unit is configured to receive the rotation signal from the sensing module, and the receiving unit is also configured to send the rotation signal to the reading unit.

16. The electronic device of claim 9, wherein the processing module is a central processing unit.

17. A method of rotating an electronic device comprising:
sensing a rotation of an electronic device rotating to receive a rotation signal and sending the rotation signal to the receiving unit by the sensing module;
receiving a current value and resetting a predetermined control value to the current value by the processing module upon determining that the current value is not equal to the control value; and
controlling a screen of the electronic device to rotate by the processing module.

18. The method of claim 17, further comprising a step of comparing the current value with the reference value by the processing module before resetting the control value to the current value.

19. The method of claim 18, wherein the step is further comprising receiving the reference value according to a first address value and receiving the control value according to a second address value by the processing module.

20. The method of claim 18, wherein the control module comprises a resetting unit and a control unit, the control unit is configured to compare the current value with the reference value, and the resetting unit is configured to reset the control value to the current value when current value is not equal the reference value.
